(19) United States
(12) Patent Application Publication
(10) Pub. No.: US 2022/0003036 A1
(43) Pub. Date: Jan. 6, 2022

(54) THERMAL RESISTANT SHEET FOR A ROOF HATCH

(71) Applicant: Cardinal IP Holding, LLC, Milwaukee, WI (US)

(72) Inventors: Anthony S. Uriarte, Muskegon, MI (US); Peter M. Schmitz, Byron Center, MI (US)

(21) Appl. No.: 16/921,739

(22) Filed: Jul. 6, 2020

(51) Int. Cl. E06B 5/10; E04D 13/00; E06B 5/01

(52) U.S. Cl. CPC E06B 5/10; E06B 5/01; E04D 13/00

(57) ABSTRACT

A roof hatch comprising at least one thermal resistant sheet having one or more sections is disclosed. The one or more sections are configured thereon to curb heat transfer. The roof hatch further comprises a frame to be installed on a roof and a hatch cover is configured for housing the thermal resistant sheet. The hatch cover and the frame are connected by a movable joint which enables the hatch cover to collapse over the frame. A sealing element is provided on at least a portion of the hatch cover. The thermal resistant sheet is held by the hatch cover by a temporary joint, a permanent joint or a combination thereof. The thickness of the hatch cover is in the range of 0.060 inches to 0.090 inches. The length of the one or more sections have a length which is less than a length of the edge.

### BACKGROUND

Roof hatches are an important part of a building. They provide protection against sun rays, hot and cold temperatures, rains, winds and other unfavorable environmental conditions.

Roof hatches fixed on a roof can be opened and closed for ventilation or lighting. The roof hatches are primarily loaded with frames, covers, fasteners, and wood or metals panels.

Conventional roof hatches are equipped with thermal insulation through the use of materials such as, but not limited to, cotton wool or polymer sheets. Such conventional thermal insulation increases the need for space for the roof hatches. Furthermore, the conventional thermal insulation increases the total weight of the roof.

In addition to the problem of weight and occupancy of space, the conventional roof hatches provide inefficient insulation which leads to condensation on the sides of the hatch that are exposed to higher temperatures and humidity.

Condensation occurs on the inner side of roof hatches when the outside temperature is low and the air within the house or residential building is conditioned with warmer air. While condensation on the outer surface of the hatch may be acceptable, when condensation occurs on the inner surface, it leads to various problems such as leakage of condensed water, damage of elements within the roof hatch, growth of bacteria and erosion of the surface itself.

Therefore, there is a need to improve thermal insulation in conventional roof hatches.

### SUMMARY

In an embodiment, a roof hatch comprising at least one thermal resistant sheet having one or more sections is disclosed. The one or more sections are configured thereon to curb heat transfer.

In another embodiment, a roof hatch comprising at least one thermal resistant sheet having one or more slots is disclosed. The one or more slots are configured thereon to curb heat transfer.

In yet another embodiment, a roof hatch comprising at least one thermal resistant sheet having a plurality of slots and bridges is disclosed. The plurality of slots and bridges are configured thereon and located near an edge of the thermal resistant sheet to curb the heat transfer towards the edge.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a perspective view of a building including a heating, ventilating, or air conditioning (HVAC) system, according to some embodiments.

FIG. 2 is a perspective view of a thermal resistant sheet 200, according to some embodiments.

FIG. 3 is a top view of a thermal resistant Sheet 300 with multiple embodiments of one or more sections or slots are defined at each edge of the four edges, according to some embodiments.

FIG. 4 is a perspective view of a Roof Hatch 400, according to some embodiments.

### DETAILED DESCRIPTION

### Overview

A roof hatch comprising at least one thermal resistant sheet having one or more sections is disclosed. The one or more sections are configured thereon to curb heat transfer. The roof hatch further comprises a frame to be installed on a roof and a hatch cover is configured for housing the thermal resistant sheet. The hatch cover and the frame are connected by a movable joint which enables the hatch cover to collapse over the frame. A sealing element is provided on at least a portion of the hatch cover. The thermal resistant sheet is held by the hatch cover by a temporary joint, a permanent joint or a combination thereof. The thickness of the hatch cover is in the range of 0.060 inches to 0.090 inches. The length of the one or more sections have a length which is less than a length of the edge.

### Building HVAC System

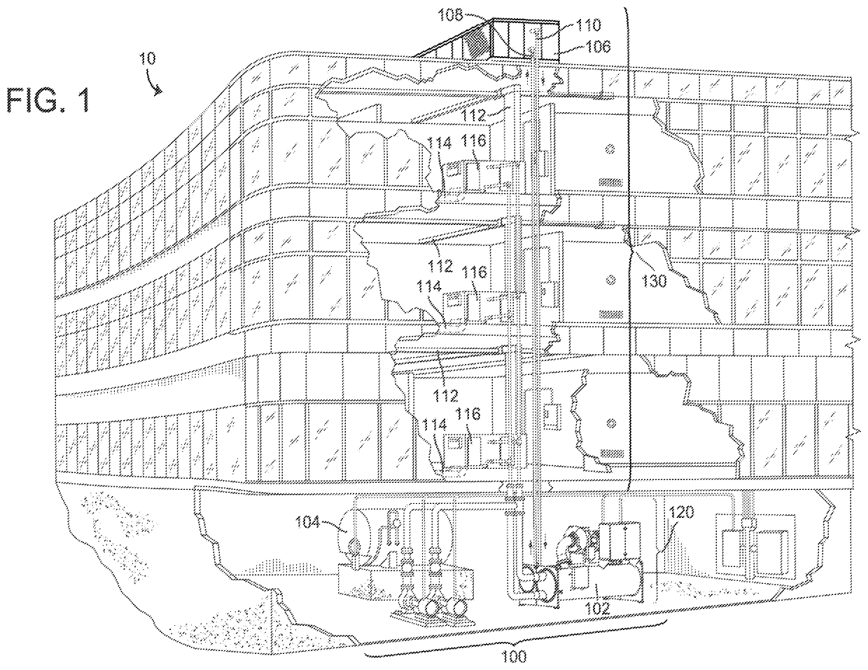

Referring now to FIG. 1, a perspective view of a building 10 is shown. Building 10 is served by a heating, ventilating, or air conditioning (HVAC) system 100. HVAC system 100 can include a plurality of HVAC devices (e.g., heaters, chillers, air handling units, pumps, fans, thermal energy storage, etc.) configured to provide heating, cooling, air conditioning, ventilation, and/or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10.

HVAC system 100 is shown to include a chiller 102, a boiler 104, and a rooftop air handling unit (RTU) 106. Waterside system 120 may use boiler 104 and chiller 102 to heat or cool a working fluid (e.g., water, glycol, etc.) and may circulate the working fluid to RTU 106. In various embodiments, the HVAC devices of waterside system 120 can be located in or around building 10 (as shown in FIG. 1) or at an offsite location such as a central plant (e.g., a chiller plant, a steam plant, a heat plant, etc.) that serves one or more buildings including building 10. The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

RTU 106 may place the working fluid in a heat exchange relationship with an airflow passing through RTU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, RTU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by RTU 106 (i.e., the supply airflow) to building 10 via air supply ducts 112 and may provide return air from building 10 to RTU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. RTU 106 can include various sensors (e.g., temperature sensors, pressure sensors, etc.) configured to measure attributes of the supply airflow. RTU 106 may receive input from sensors located within AHU 106 and/or within the building zone and may adjust the flow rate, temperature, or other attributes of the supply airflow through RTU 106 to achieve set point conditions for the building zone.

### A Thermal Resistant Sheet for a Roof Hatch

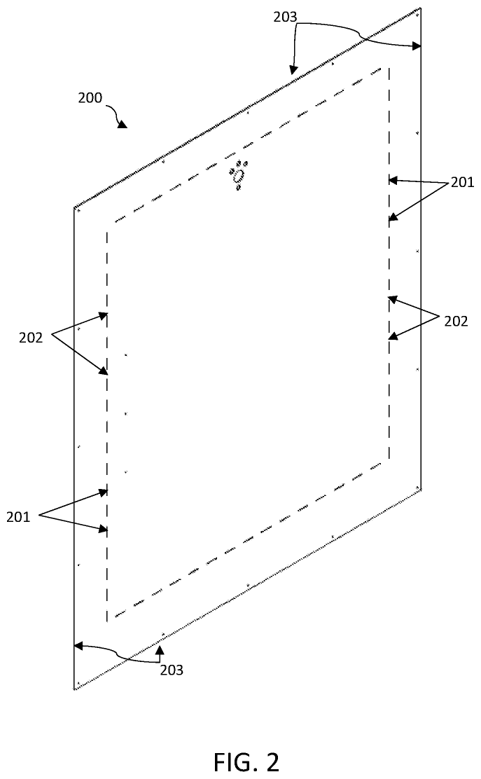

Referring now to FIG. 2, a perspective view of a thermal resistant sheet 200 is shown, according to one embodiment. The thermal resistant sheet 200 is further configured thereon with one or more sections 201. The one or more sections 201 may be hollow sections which may eliminate the heat transfer by conduction. FIG. 2 discloses the plurality of sections which may be in the form of slots and may be connected by one or more bridges 202. The sections in the form of slots and the bridges are further illustrated near each edge 203 of the thermal resistant sheet 200. In an embodiment, the one or more sections 201 may be also present as a single section along at least one edge of all the edges of the thermal resistant sheet 200 and may be configured with plurality of sections along at least one edge of all the edges. These embodiments are further disclosed in the present specification.

The one or more sections 201 located near each edge of the thermal resistant sheet 200 may facilitate the prevention of heat transfer from the center of the thermal resistant sheet 200 towards the edges of the thermal resistant sheet 200.

The one or more sections 201 may be in the form of slots, slits, holes, scored sections, sliced sections and cut sections. The one or more sections 201 may be created by using manufacturing processes such as, but not limited to, drilling, stamping, laser cutting, milling, scoring or slicing. One of the primary purposes of the one or more sections 201 is to increase resistance in the heat transfer, where the heat transfer is in the direction from the center of sheet 200 towards the edges. In an exemplary embodiment, the resistance to the heat transfer may also be in the direction leading from the edges to the center of the thermal resistant sheet 200.

In one embodiment, the process of drilling may be enabled by a drilling machine or by a Computer Numeric Control (CNC) machine. The process of stamping may be enabled by a stamping machine or by a press machine equipped with a stamp as required for manufacturing of the thermal resistant sheet 200. The laser cutting process may be enabled by a laser cutting machine configured to cut and etch on a sheet made from polymer, metal or a metal polymer composite. The process of milling may be enabled by a milling machine or by a vertical milling machine.

The material used for the production of the thermal resistant sheet 200 is selected from stainless steel, aluminum or a combination thereof. Composite materials including stainless steel, aluminum or a combination thereof may be present as base material which may be combined with thermal resistive materials having low thermal conductivity and high strength.

In an embodiment, the thermal resistive sheet may comprise one or more slots wherein one or more bridges 202 may be located between the one or more slots. In the same embodiment, a section may comprise two or more slots and a bridge may be connected between at least two slots.

In yet another embodiment, a thermal resistive section may comprise one or more sections 201 near at least one edge wherein a length of the one or more sections 201 is less than the length of a proximate edge of the thermal resistive sheet. Moreover, the sum of the length of the one or more sections which are in-line is less than a length of the proximate edge.

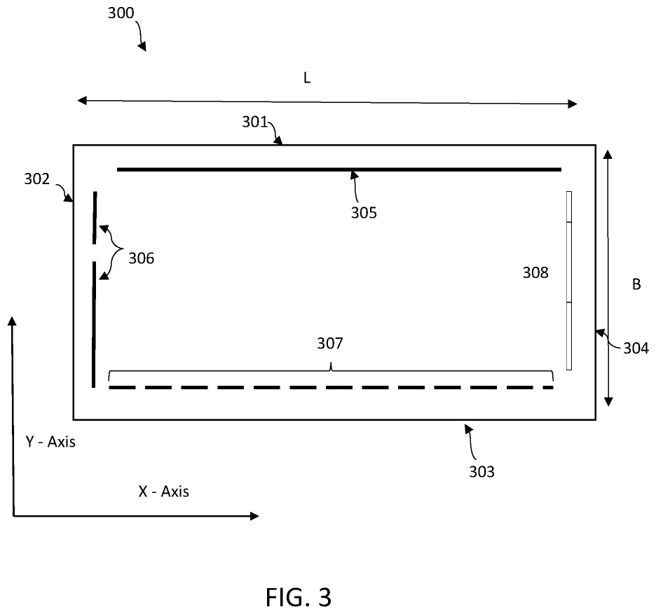

For the requirement of the thermal resistant sheet 200, a length of any section or any slot present in any form may be of a length of the section or slot less than length of a proximate edge. The same limitation of length may be used for a sum of lengths of one or more sections 201 or slots which are inline, wherein the sum of lengths of the sections 201 may be less than that of the proximate edge of the sheet 200. An exemplary embodiment of this configuration may be seen in FIG. 3.

The sections 201 limit or prevent the heat transfer towards the edges as conduction is obstructed. Further, airflow through the sections 201 may be negligible when the thermal resistant sheet is covered which leads to a minimum heat transfer through convection. The bridges 202 act as the heat transfer medium for transferring the heat from the center of the sheet 200 to the edges of the sheet 200. The heat transfer resistance is proportional to the number and the length of the sections or slots. Further, the heat transfer rate is proportional to the length and number of bridges connecting the slots or sections. In an embodiment, the bridges can also be configured for providing strength to the thermal resistant sheet so that the portion of the thermal resistant sheet beyond the section and towards the edge of the sheet 200 do not break when an external force is applied.

FIG. 3 discloses a top view of a Thermal resistant Sheet 300 with multiple embodiments of one or more sections or slots are defined at each edge of the four edges (301, 302, 303, and 304) wherein the sections or slots defined at each edge is a non-limiting embodiment. The thermal resistant sheet 300 is defined by a length L measured along X-axis and breadth B measured along Y-axis.

The region near edge 301 is configured with one section 305 which may be a slot and may extend on the thermal resistance sheet 300 along the length L and in the direction of X-Axis and therefore a length of the section 305 is less than the length L of the thermal resistant sheet 300.

The region near edge 302 is configured with two slots 306 and extend in line on the thermal resistance 300 sheet along the breadth B and in the direction of Y-Axis and therefore sum of lengths of the slots 306 is less than the breadth B of the thermal resistant sheet 300.

The region near edge 303 is configured with a plurality sections 307 in the form of slots and extend in line on the thermal resistance sheet 300 along the length L and in the direction of X-Axis and therefore sum of lengths of the section 307 is less than the length L of the thermal resistant sheet 300.

The region near edge 304 is configured with one section 308 having plurality of slots which may be connected by bridges wherein the section 308 extends on the thermal resistance sheet along the breadth L and in the direction of Y-Axis and therefore a length of the section having the slot is less than the breadth B of the thermal resistant sheet 300.

In an embodiment, the edges (301, 302, 303 and 304) are illustrated and described having sections or slots different from each other. In another embodiment, all edges may have a configuration of single section as illustrated for edge 301. In yet another embodiment, all edges may have a configuration of slots as illustrated for edge 302. Further, all edges may have a configuration of sections as illustrated for edge 303. In yet another embodiment, all edges may have a configuration of a section as illustrated for edge 304. In yet another embodiment, all edges or any one edge may have a configuration which can be a combination of sections and slots as disclosed and illustrated at edges (301, 302, 303, and 304).

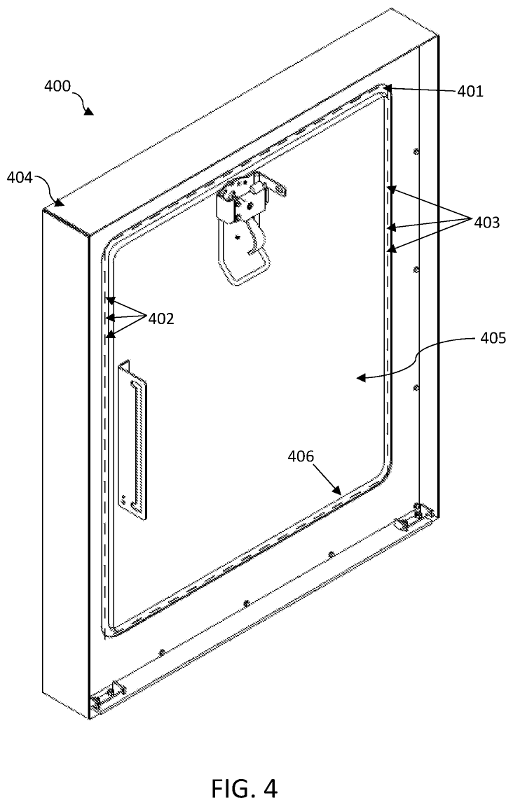

FIG. 4 shows a perspective view of a roof hatch 400 is shown. The roof hatch 400 comprises a thermal resistant sheet 401 with one or more sections 402 and one or more bridges 403. The roof hatch 400 further comprises a frame 404 which is affixed over an opening present on the roof. A hatch cover 405 is connected to the frame 404 by a movable joint. The movable joint may enable the hatch cover 405 to collapse over the frame 404 and close the opening present within the frame 404. A sealing element 406 (shown as transparent with only borders to show the sections of the thermal resistant sheet 401) is attached on at least a portion of the hatch cover 405 to facilitate an airtight sealing when the hatch cover 405 collapses over the frame 404.

The thermal resistant sheet 401 may be configured with one or more sections 402 and one or more bridges 403 similar to the configuration of sections and slots as described in FIG. 2 or may have variations of the single section, single slots, two or more slots in one section as disclosed in the embodiments of the FIG. 2 and in FIG. 3.

The frame 404 may be made from a suitable weather resistant material and may comprise metals, non-metal, metal composites, metal and non-metal composites. The metals may comprise stainless steel and aluminum. The metal composites may be a mixture of metals which may enable to create a metal composite material having a required strength and capable of blocking the heat transfer. The non-metals may comprise polymers which limit or resist the heat transfer.

The hatch cover 405 is capable to house the thermal resistant sheet 401. The thermal resistant sheet 401 is held by the hatch cover 405 by a temporary joint, a permanent joint or a combination thereof. In an embodiment, the temporary joint is at least one of a nut and bolt joint, a flange and flap joint, and a screw joint and the permanent joint is at least one of a rivet joint, a weld joint, a brazed joint, and a stud joint.

The hatch cover 405 can be swiveled, rotated, pivoted at the movable joint connected over the frame 404. The movable joint may be selected from a group consisting of a pivot joint, a hinge joint, a ball and socket joint, a hinge spring joint and a swivel joint. The movable joint enables the hatch cover 405 to collapse and de-collapse over the frame 404. The collapsing and de-collapsing of the hatch cover 405 enables to open and close the opening completely as well as partially. The partial opening and closing may be enabled by one of a locking lever, lockable hinge and a 90 degree locking hinge.

The sealing element 406 may be a seal, a gasket or a combination thereof. The aim of providing the sealing element 406 to ensure no air or particle is passed through the roof hatch 400. In an embodiment, the sealing element 406 may be present on the frame 404 in the form of a gasket. The sealing element 406 may be made from a polymer or a plastic gasket.

The roof hatch 400 may further comprise auxiliary elements comprising hatch cover handle, hatch cover latch and one or more brackets as disclosed in the FIG. 4.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

What is claimed is:

1. A roof hatch comprising at least one thermal resistant sheet having one or more sections configured thereon to curb heat transfer through the one or more sections.

2. The roof hatch of claim 1, wherein the one or more sections comprise at least one of slots, slits, holes, hollow sections, scored sections, sliced sections, and cut sections.

3. The roof hatch of claim 1, wherein the one or more sections are configured to be located near an edge of the thermal resistant sheet to curb transfer of heat towards the edge.

4. The roof hatch of claim 1, further comprises a frame to be installed on a roof.

5. The roof hatch of claim 1, further comprises a hatch cover configured for housing the thermal resistant sheet.

6. The roof hatch of claim 5, wherein the hatch cover is capable of collapsing.

7. The roof hatch of claim 6, wherein the collapse of the hatch cover is enabled by a movable joint selected from the group consisting of a pivot joint, a hinge joint, a ball and socket joint, a hinge spring joint and a swivel joint.

8. The roof hatch of claim 5, wherein a sealing element is provided on at least a portion of the hatch cover to facilitate an airtight sealing when the hatch cover collapses.

9. The roof hatch of claim 8, wherein the sealing element is one of a gasket, seal or a combination thereof.

10. The roof hatch of claim 1, wherein the one or more sections of the thermal resistant sheet comprises one or more bridges located between two slots.

11. The roof hatch of claim 5, wherein the thermal resistant sheet is held by the hatch cover by a temporary joint, a permanent joint or a combination thereof.

12. The roof hatch of claim 11, wherein the temporary joint is at least one of a nut and bolt joint, a flange and flap joint, and a screw joint and the permanent joint is at least one of a rivet joint, a weld joint, a brazed joint, and a stud joint.

13. The roof hatch of claim 3, wherein the one or more sections have a length which is less than a length of the edge.

14. The roof hatch of claim 1, wherein the thermal resistant sheet has a thickness in the range of 0.060 inches to 0.090 inches.

15. A roof hatch comprising at least one thermal resistant sheet having one or more slots configured thereon to curb heat transfer through the one or more slots.

16. The roof hatch of claim 15, wherein the one or more slots are selected from the group consisting of slits, holes, hollow sections, scored sections, sliced sections and cut sections.

17. The roof hatch of claim 15, further comprises one or more bridges located adjacent to the one or more slots.

18. The roof hatch of claim 15, wherein the one or more slots are configured to be located near at least a portion of an edge of the thermal resistant sheet.

19. A roof hatch comprising at least one thermal resistant sheet having a plurality of slots and bridges configured thereon and located near an edge of the thermal resistant sheet to curb the heat transfer towards the edge.

20. A roof hatch of claim 19, wherein at least one or more of the plurality of slots extend along a length of the edge.
